(19) United States
(12) Patent Application Publication
(10) Pub. No.: US 2018/0313540 A1
(43) Pub. Date: Nov. 1, 2018

(54) Acoustic Damper for Gas Turbine Engine Combustors

(71) Applicant: General Electric Company, Schenectady, NY (US)

(72) Inventors: Sharath Bangalore Nagaraja, Clifton Park, NY (US); Owen Graham, Niskayuna, NY (US); Kwankoo Kim, Montgomery, OH (US); Manampathy Gangadharan Giridharan, Cincinnati, OH (US); Gregory Allen Boardman, Liberty Township, OH (US)

(21) Appl. No.: 15/582,946

(22) Filed: May 1, 2017

(51) Int. Cl. F23R 3/10; F02C 7/045; F02C 3/04

(52) U.S. Cl. CPC F23R 3/10; F02C 3/04; F02C 7/045

(57) ABSTRACT

The present disclosure is directed to a combustor assembly for a gas turbine engine. The combustor assembly defines a combustion chamber and a diffuser cavity disposed upstream of the combustion chamber. The combustor assembly includes an acoustic damper that includes an aft wall adjacent to the combustion chamber and a forward wall adjacent to the diffuser cavity. A connecting wall is extended at least along the longitudinal direction and coupled to the aft wall and the forward wall. A damper cavity is defined by the connecting wall, the aft wall, and the forward wall.

### FIELD

The present subject matter relates generally to gas turbine engine combustion assemblies. More particularly, the present subject matter relates to acoustic damping structures for gas turbine engine combustion assemblies.

### BACKGROUND

Pressure oscillations generally occur in combustion sections of gas turbine engines resulting from the ignition of a fuel and air mixture within a combustion chamber. While nominal pressure oscillations are a byproduct of combustion, increased magnitudes of pressure oscillations may result from generally operating a combustion section at lean conditions, such as to reduce combustion emissions. Increased pressure oscillations may damage combustion sections and/or accelerate structural degradation of the combustion section in gas turbine engines, thereby resulting in engine failure or increased engine maintenance costs. As gas turbine engines are increasingly challenged to reduce emissions, systems of attenuating combustion gas pressure oscillations are needed to enable reductions in gas turbine engine emissions while maintaining or improving the structural life of combustion sections.

Therefore, there exists a need for a dampening structure that may attenuate pressure oscillations across the operating range of the combustion section of an engine.

### BRIEF DESCRIPTION

Aspects and advantages of the invention will be set forth in part in the following description, or may be obvious from the description, or may be learned through practice of the invention.

The present disclosure is directed to a combustor assembly for a gas turbine engine. The combustor assembly defines a combustion chamber and a diffuser cavity disposed upstream of the combustion chamber. The combustor assembly includes an acoustic damper that includes an aft wall adjacent to the combustion chamber and a forward wall adjacent to the diffuser cavity. A connecting wall is extended at least along the longitudinal direction and coupled to the aft wall and the forward wall. A damper cavity is defined by the connecting wall, the aft wall, and the forward wall.

In various embodiments, the aft wall defines a damper passage extended from the combustion chamber to the damper cavity. In one embodiment, the aft wall defines a first orifice and a second orifice each at the damper passage. The first orifice provides fluid communication from the damper cavity to the damper passage. The second orifice provides fluid communication from the combustion chamber to the damper passage. In one embodiment, the damper passage extends at least partially along the longitudinal direction from the first orifice to the second orifice. In another embodiment, the aft wall defines the damper passage extended at least partially along a radial direction. The damper passage defines a serpentine passage, an angled passage at least partially along the radial direction, or both.

In one embodiment, the forward wall defines a third orifice providing fluid communication from the diffuser cavity to the damper cavity.

In another embodiment, the connecting wall defines a cylindrical, oblong, or polyhedron wall defining the damper cavity.

In other embodiments, the acoustic damper further includes an intermediate wall disposed within the damper cavity between the aft wall and the forward wall. The intermediate wall is coupled to at least a portion of the connecting wall. The intermediate wall defines two or more damper cavity subsections. In one embodiment, the intermediate wall defines an intermediate wall orifice extended through the intermediate wall.

In various embodiments, the combustor assembly further includes an annular dome wall extended generally along the radial direction and adjacent to the combustion chamber. The acoustic damper extends at least partially through the dome wall from the diffuser cavity and adjacent to the combustion chamber. In one embodiment, the aft wall of the acoustic damper and the dome wall together define a threaded interface. In another embodiment, an outer diameter of the aft wall defines a plurality of threads coupled to the dome wall. In still another embodiment, the connecting wall of the acoustic damper comprises a radially extended portion forward of and adjacent to the threaded interface.

In one embodiment, the combustor assembly includes a plurality of acoustic dampers disposed in circumferential arrangement through the dome wall. In an embodiment, the acoustic dampers are in symmetric or asymmetric circumferential arrangement through the dome wall.

The present disclosure is further directed to a gas turbine engine including the combustor assembly including the damper assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross sectional view of an exemplary gas turbine engine incorporating an exemplary embodiment of a combustor assembly;

FIG. 2 is a partial perspective view of an exemplary embodiment of a combustor assembly of the exemplary engine shown in FIG. 1;

FIG. 3 is an axial cross sectional view of an exemplary embodiment of an acoustic damper of the combustor assembly shown in FIG. 2;

FIG. 4 is an axial cross sectional view of another exemplary embodiment of an acoustic damper of the combustor assembly shown in FIG. 2;

FIG. 5 is an axial cross sectional view of yet another exemplary embodiment of an acoustic damper of the combustor assembly shown in FIG. 2; and

FIG. 6 is a circumferential view of the combustor assembly shown in FIG. 2.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows. The terms “upstream of” or “downstream of” generally refer to directions toward “upstream 99” or toward “downstream 98”, respectively, as provided in the figures.

A combustor assembly for a gas turbine engine including an acoustic damper is generally provided that may attenuate pressure oscillations across the range of engine operating conditions. The acoustic damper includes an aft wall adjacent to a combustion chamber, a forward wall adjacent to a diffuser cavity, and a connecting wall extended along a longitudinal direction and coupled to the aft wall and the forward wall. A damper cavity is defined by the connecting wall, the aft wall, and the forward wall.

The combustor assembly including the acoustic damper may attenuate pressure oscillations characterized by high pressure fluctuations that are sustained in the hot side (e.g., combustion chamber) and the cold side (e.g., the diffuser cavity) of a combustion section. The acoustic damper may mitigate such pressure oscillations by enabling fluid communication of the damper cavity with the combustion chamber (e.g., combustion gas pressure within the combustor assembly) while also enabling fluid communication of the damper cavity with the diffuser cavity (e.g., compressor exit pressure within the combustor assembly). Damping both the diffuser cavity and the combustion chamber pressure outputs may attenuate pressure oscillations over a broad range of low and high frequencies. Additionally, the acoustic damper may be coupled throughout an annulus of the combustor assembly or at select annular locations therein to suppress desired acoustic modal shapes of interest in annular and can annular combustor assemblies. The acoustic damper may also be differently sized at various locations through the annulus of the combustor assembly to suppress a range of acoustic modes of interest. The acoustic damper may include a threaded interface with a dome wall of the combustor assembly to facilitate easy and relatively quick changes or customizations of the acoustic damper to the combustor assembly.

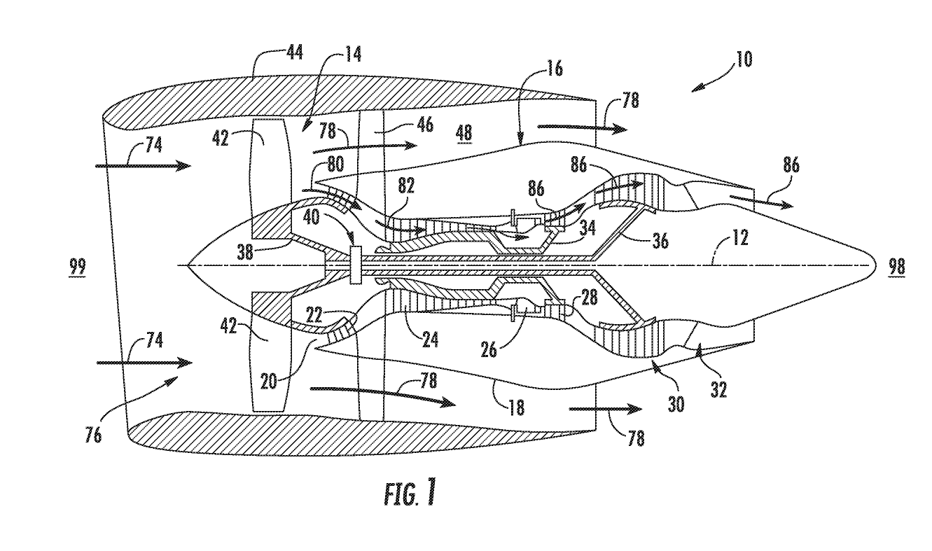

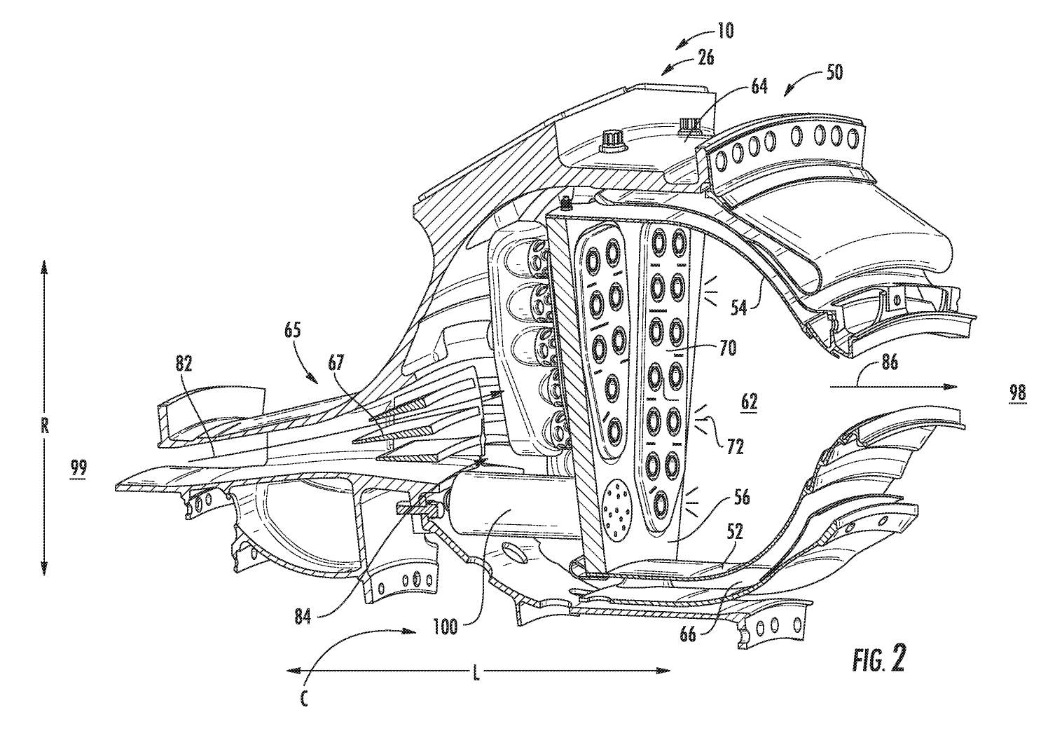

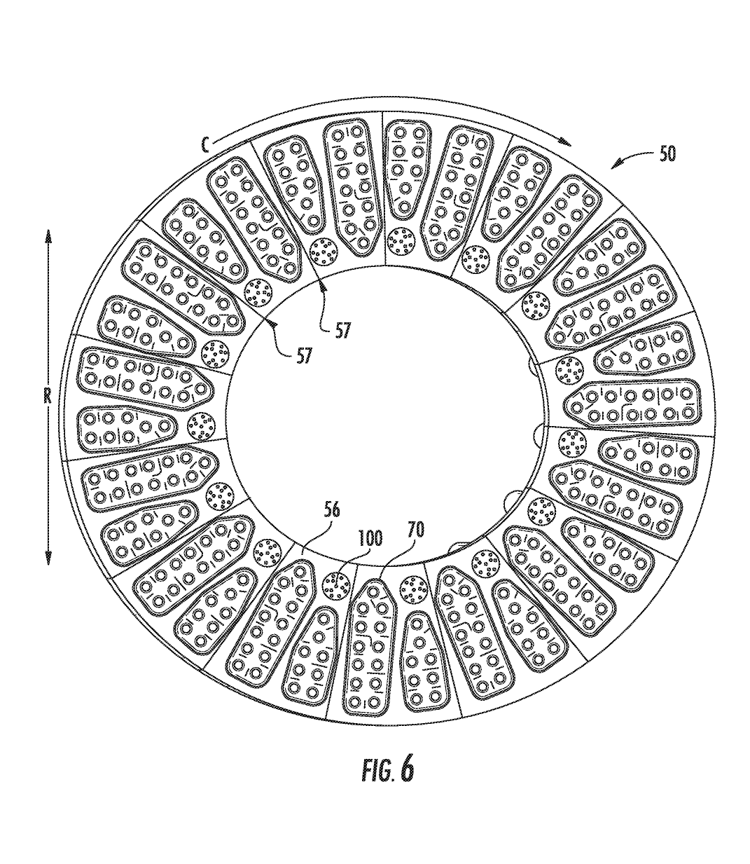

Referring now to the drawings, FIG. 1 is a schematic partially cross-sectioned side view of an exemplary high by-pass turbofan engine 10 herein referred to as “engine 10” as may incorporate various embodiments of the present disclosure. Although further described below with reference to a turbofan engine, the present disclosure is also applicable to turbomachinery in general, including turbojet, turboprop, and turboshaft gas turbine engines, including marine and industrial turbine engines and auxiliary power units. As shown in FIG. 1, the engine 10 has a longitudinal or axial centerline axis 12 that extends there through for reference purposes and generally along a longitudinal direction L. The engine 10 further defines a radial direction R extended from the axial centerline 12, and a circumferential direction C (shown in FIGS. 2 and 6) around the axial centerline 12. The engine 10 further defines an upstream end 99 and a downstream 98 generally opposite of the upstream end 99 along the longitudinal direction L. In general, the engine 10 may include a fan assembly 14 and a core engine 16 disposed downstream from the fan assembly 14.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 by way of a reduction gear 40 such as in an indirect-drive or geared-drive configuration. In other embodiments, the engine 10 may further include an intermediate pressure (IP) compressor and turbine rotatable with an intermediate pressure shaft.

As shown in FIG. 1, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. In one embodiment, the nacelle 44 may be supported relative to the core engine 16 by a plurality of circumferentially-spaced outlet guide vanes or struts 46. Moreover, at least a portion of the nacelle 44 may extend over an outer portion of the core engine 16 so as to define a bypass airflow passage 48 therebetween.

FIG. 2 is a cross sectional side view of an exemplary combustion section 26 of the core engine 16 as shown in FIG. 1. As shown in FIG. 2, the combustion section 26 may generally include an annular type combustor 50 having an annular inner liner 52, an annular outer liner 54 and a dome wall 56 that extends radially between upstream ends 58, 60 of the inner liner 52 and the outer liner 54 respectfully. In other embodiments of the combustion section 26, the combustion assembly 50 may be a can or can-annular type. As shown in FIG. 2, the inner liner 52 is radially spaced from the outer liner 54 with respect to engine centerline 12 (FIG. 1) and defines a generally annular combustion chamber 62 therebetween.

As shown in FIG. 2, the inner liner 52 and the outer liner 54 may be encased within an outer casing 64. An outer flow passage 66 may be defined around the inner liner 52, the outer liner 54, or both. The inner liner 52 and the outer liner 54 may extend from the dome wall 56 towards a turbine nozzle or inlet 68 to the HP turbine 28 (FIG. 1), thus at least partially defining a hot gas path between the combustor assembly 50 and the HP turbine 28. A fuel nozzle 70 may extend at least partially through the dome wall 56 and provide a fuel-air mixture 72 to the combustion chamber 62.

During operation of the engine 10, as shown in FIGS. 1 and 2 collectively, a volume of air as indicated schematically by arrows 74 enters the engine 10 through an associated inlet 76 of the nacelle 44 and/or fan assembly 14. As the air 74 passes across the fan blades 42 a portion of the air as indicated schematically by arrows 78 is directed or routed into the bypass airflow passage 48 while another portion of the air as indicated schematically by arrow 80 is directed or routed into the LP compressor 22. Air 80 is progressively compressed as it flows through the LP and HP compressors 22, 24 towards the combustion section 26. As shown in FIG. 2, the now compressed air as indicated schematically by arrows 82 flows across a compressor exit guide vane (CEGV) 67 and through a prediffuser 65 into a diffuser cavity or head end portion 84 of the combustion section 26.

The prediffuser 65 and CEGV 67 condition the flow of compressed air 82 to the fuel nozzle 70. The compressed air 82 pressurizes the diffuser cavity 84. The compressed air 82 enters the fuel nozzle 70 to mix with a fuel. The fuel nozzles 70 premix fuel and air 82 within the array of fuel injectors with little or no swirl to the resulting fuel-air mixture 72 exiting the fuel nozzle 70. After premixing the fuel and air 82 within the fuel nozzles 70, the fuel-air mixture 72 burns from each of the plurality of fuel nozzles 70 as an array of compact, tubular flames.

Referring to FIG. 2, the combustor assembly 50 includes an acoustic damper 100 disposed generally upstream of the combustion chamber 62 and extended into the diffuser cavity 84. One or more acoustic dampers 100 may be disposed in circumferential arrangement along the circumferential direction C and at least partially through the dome wall 56. In various embodiments, the acoustic dampers 100 are generally flush or even with the dome wall 56 within the combustion chamber 62 (i.e., generally not protruding into the combustion chamber 62 from the dome wall 56).

Referring still to FIGS. 1 and 2 collectively, the combustion gases 86 generated in the combustion chamber 62 flow from the combustor assembly 50 into the HP turbine 28, thus causing the HP rotor shaft 34 to rotate, thereby supporting operation of the HP compressor 24. As shown in FIG. 1, the combustion gases 86 are then routed through the LP turbine 30, thus causing the LP rotor shaft 36 to rotate, thereby supporting operation of the LP compressor 22 and/or rotation of the fan shaft 38. The combustion gases 86 are then exhausted through the jet exhaust nozzle section 32 of the core engine 16 to provide propulsive thrust.

As the fuel-air mixture burns, pressure oscillations occur within the combustion chamber 62. These pressure oscillations may be driven, at least in part, by a coupling between the flame's unsteady heat release dynamics, the overall acoustics of the combustor 50 and transient fluid dynamics within the combustor 50. The pressure oscillations generally result in undesirable high-amplitude, self-sustaining pressure oscillations within the combustor 50. These pressure oscillations may result in intense, frequently single-frequency or multiple-frequency dominated acoustic waves that may propagate within the generally closed combustion section 26.

Depending, at least in part, on the operating mode of the combustor 50, these pressure oscillations may generate acoustic waves at a multitude of low or high frequencies. These acoustic waves may propagate downstream from the combustion chamber 62 towards the high pressure turbine 28 and/or upstream from the combustion chamber 62 back towards the diffuser cavity 84 and/or the outlet of the HP compressor 24. In particular, as previously provided, low frequency acoustic waves, such as those that occur during engine startup and/or during a low power to idle operating condition, and/or higher frequency waves, which may occur at other operating conditions, may reduce operability margin of the turbofan engine and/or may increase external combustion noise, vibration, or harmonics.

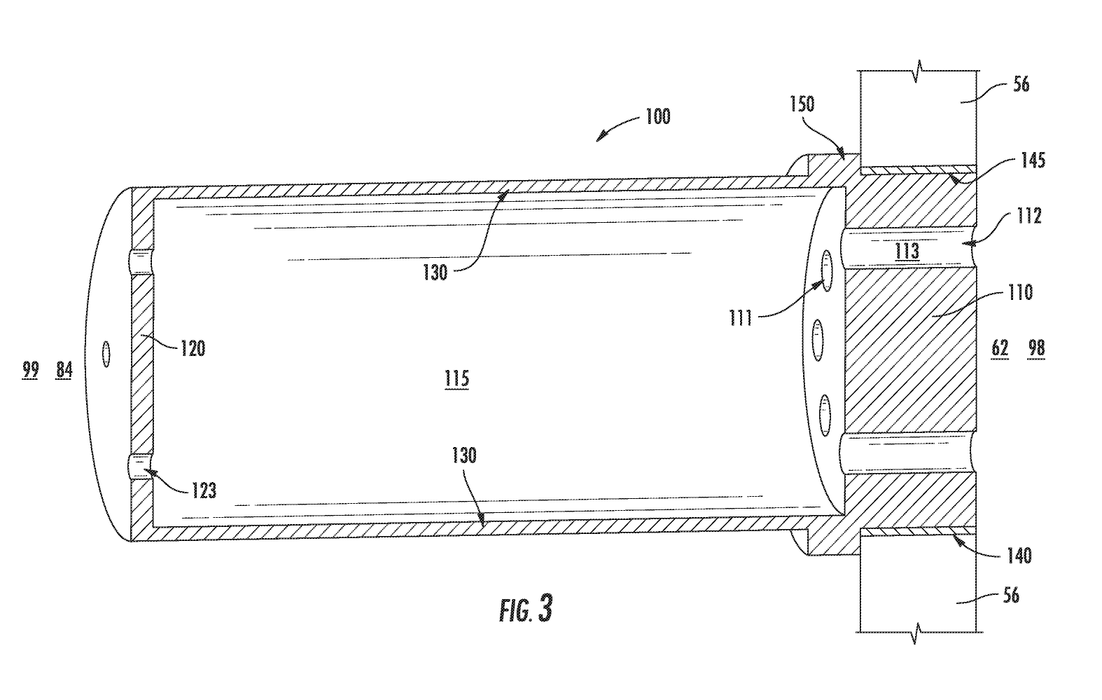

Referring now to FIGS. 3-5, an axial or longitudinal cross sectional view of the acoustic damper 100 of the combustor assembly 50 is generally provided. The acoustic damper 100 includes an aft wall 110 adjacent to the combustion chamber 62 and a forward wall 120 adjacent to the diffuser cavity 84. A connecting wall 130 is extended along the longitudinal direction L and is coupled to the aft wall 110 and the forward wall 120. A damper cavity 115 is defined by the connecting wall 130, the aft wall 110, and the forward wall 120.

In various embodiments, the connecting wall 130 may define a generally cylindrical wall. In other embodiments, the connecting wall 130 may define a conical or frusto-conical wall, in which the aft wall 110 defines a larger or smaller diameter than the forward wall 120. In still other embodiments, the connecting wall 130, the forward wall 120, or both may each define an oblong cross sectional area, such as an ovular, rectangular, or rounded-rectangular cross section. In still other embodiments, the damper assembly 100 may at least partially define a polyhedron in which the connecting wall 130, the forward wall 120, or both may each define a polygonal cross sectional area.

In one embodiment, the forward wall 120 defines a third orifice 123 providing fluid communication from the diffuser cavity 84 to the damper cavity 62.

In various embodiments, the aft wall 110 defines a damper passage 113 extended from the combustion chamber 62 to the damper cavity 115. The aft wall 110 may define a first orifice 111 and a second orifice 112 each at the damper passage 113. The first orifice 111 provides fluid communication from the damper cavity 115 to the damper passage 113. The second orifice 112 provides fluid communication from the combustion chamber 62 to the damper passage 113. In various embodiments, a plurality of the damper passage 113 may be defined in symmetric or asymmetric arrangement through the aft wall 110 of the damper assembly 100.

In one embodiment, the damper passage 113 extends generally along the longitudinal direction L from the first orifice 111 to the second orifice 112. For example, the damper passage 113 may generally define a cylindrical bore through the aft wall 110.

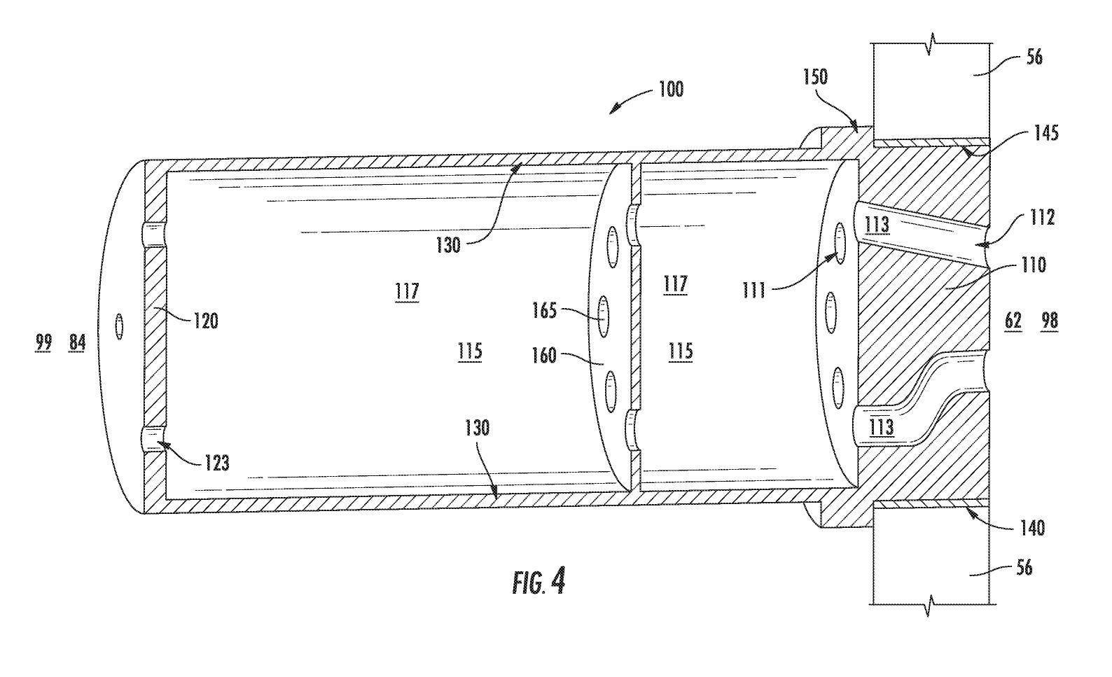

In another embodiment, such as shown in the exemplary embodiment of the damper assembly 100 shown in FIG. 4, the damper passage 113 defines a serpentine passage along longitudinal direction L and one or both of radial direction R and circumferential direction C (shown in FIGS. 2 and 6). In another embodiment, the damper passage 113 extends at least partially along the longitudinal direction L and one or both of radial direction R and circumferential direction C to define a straight angled passage to the combustion chamber 62.

In various embodiments, the damper passage 113 through the aft wall 110 provides fluid communication from the combustion chamber 62 to the damper cavity 115 to attenuate pressure oscillations from combustion. The damper passage 113 may further provide thermal attenuation (e.g., cooling) at the aft wall 110.

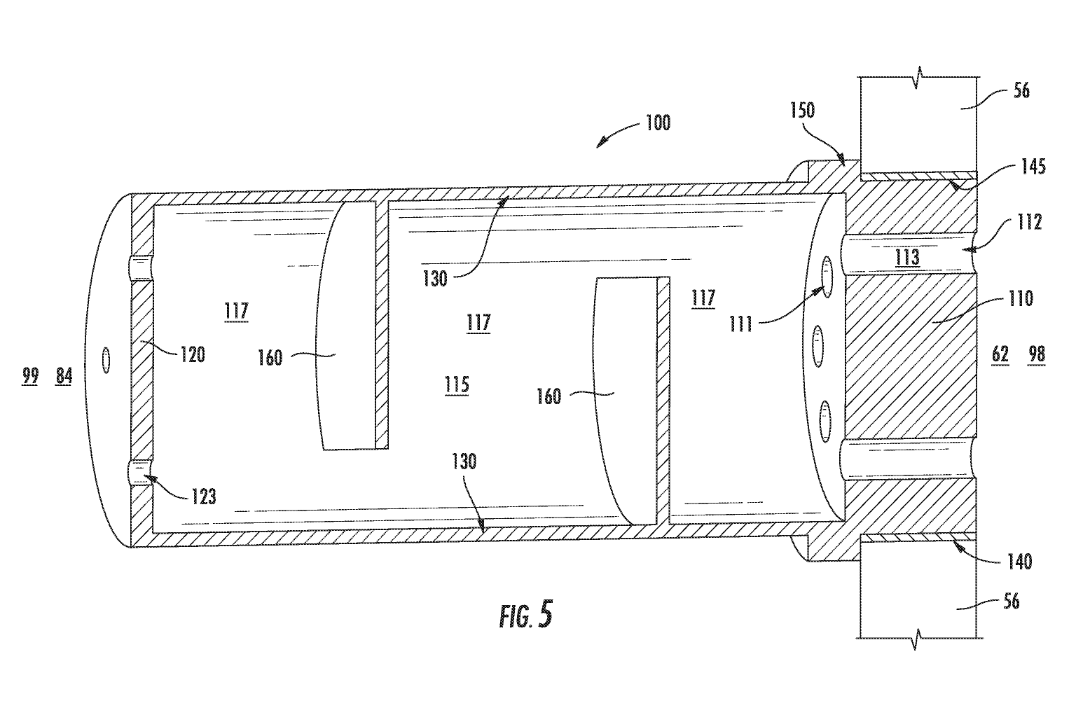

Referring now to FIGS. 4-5, other exemplary embodiments of the damper assembly 100 are generally provided. The exemplary embodiments shown in FIGS. 4-5 further include an intermediate wall 160 disposed within the damper cavity 115 between the aft wall 110 and the forward wall 120.

In various embodiments, the intermediate wall 160 is coupled to at least a portion of the connecting wall 130. The intermediate wall 160 defines within the damper cavity 115 two or more damper cavity subsections 117 in fluid communication with one another. In one embodiment, as shown in FIG. 4, the intermediate wall 160 extends generally completely along the connecting wall 130 within the damper cavity 115 and provides fluid communication between each damper cavity subsection 117 through an intermediate wall orifice 165.

In another embodiment, as shown in FIG. 5, the intermediate wall 160 extends partially along the connecting wall 130 within the damper cavity 115. Referring to FIGS. 4-5, in various embodiments, a plurality of intermediate wall 160 may extend from the connecting wall 130 to define a plurality of damper cavity subsections 117. The intermediate wall 160 may enable modification of each damper assembly 100 to target specific ranges of target frequencies for attenuation, or broaden an effective range of frequency of the damper assembly 100.

It should be appreciated that the damper assembly 100 may include a plurality of intermediate wall 160 defining a plurality of damper cavity subsections 117 that may target specific ranges of target frequencies or broaden the effective range of frequency of the damper assembly.

Referring now to FIGS. 2-5, in various embodiments the aft wall 110 of the acoustic damper 100 and the dome wall 56 together define a threaded interface 140. The aft wall 110 may define at an outer diameter 145 a plurality of threads at the threaded interface 140. The dome wall 56 may further define at the threaded interface 140 a plurality of threads complimentary to those of the outer diameter 140 of the aft wall 110 of the acoustic damper 100. The threaded interface 140 defined by the acoustic damper 100 and the dome wall 56 provides generally easy and relatively quick installation, removal, and customization of various acoustic dampers 100 at the combustor assembly 50. As such, a plurality of acoustic dampers 100 may be provided around the annulus of the combustor assembly 50 at various circumferential locations of the dome wall 56 configured to attenuate different ranges of pressure oscillations. For example, a first plurality of acoustic dampers 100 may be configured to attenuate a lower frequency range of pressure oscillations, such as during startup and low power, and a second plurality of acoustic dampers 100 may be configured to attenuate a higher frequency range of pressure oscillations at higher power conditions.

In another embodiment, the connecting wall 130, the aft wall 110, or both define a radially extended portion 150 forward of and adjacent to the threaded interface 140. For example, the radially extended portion 150 may generally abut the upstream end 99 of the dome wall 56. The radially extended portion 150 may generally provide a stop that enables a desired relationship between the downstream end 98 of the aft wall 110 and the downstream end 98 of the dome wall 62 within the combustion chamber 62. For example, the radially extended portion 150 may place or set the location of the acoustic damper 100 to prevent excessive protrusion of the damper 100 into the combustion chamber 62.

The damper passage 113 may each be sized at least partially based on a length over diameter (L/D) related to a target frequency, or range thereof, for the damper cavity 115 and the acoustic damper 100 to attenuate. For example, the damper passage 113 defines a length from the first orifice 111 to the second orifice 112. The first orifice 111, the second orifice 112, or both defines a diameter of the damper passage 113. The diameter of the first orifice 111, second orifice 112, or both and the length of the damper passage 113 are each defined, at least in part, by a target frequency, or range thereof, of pressure oscillations to attenuate within the damper cavity 115 of the acoustic damper 100.

In various embodiments, the target frequency, or range thereof, of pressure oscillations of which acoustic damper 100 may attenuate may be defined by the equation:

$$f = \frac{c}{2 π} √ ( \frac{A}{{VL}^{′}} )$$

where f is the frequency, or range thereof, of pressure oscillations to be attenuated; c is the velocity of sound in the fluid (i.e., air or combustion gases); A is the cross sectional area of the opening of the damper passage 113, calculated from the diameter of the first orifice 111 and/or the second orifice 112; V is the volume of the damper cavity 115; and L′ is the effective length of the damper passage 113. In various embodiments, the effective length is the length of the damper passage 113 (e.g., from the first orifice 111 to the second orifice 112) plus a correction factor generally understood in the art multiplied by the diameter of the area of the damper passage 113.

In still various embodiments, one or more damper passages 113 may define different areas relative to one another within a single acoustic damper 100. For example, where the acoustic damper 100 includes a plurality of damper passages 113 leading to the damper cavity 115, one or more of the damper passages 113 may define a cross sectional area opening A of the damper passage 113 different from other damper passages 113 of the same acoustic damper 100. Such differences in cross sectional area opening may include differences in diameter of the first orifice 111 or the second orifice 112 for each damper passage 113. As such, a single acoustic damper 100 may be configured to attenuate a range of frequencies of pressure oscillations.

Referring now to FIG. 6, a circumferential view of the combustor assembly 50 of the engine 10 of FIGS. 1-5 is generally provided. The circumferential view of the combustor assembly 50 provided in FIG. 6 includes an embodiment providing a circumferential arrangement of the acoustic dampers 100 through the dome wall 56. The acoustic dampers 100 are generally disposed inward along the radial direction R of the fuel nozzles 70. In various embodiments the acoustic dampers 100 are disposed among several fuel nozzles 70. As described elsewhere herein, one or more of the acoustic dampers 100 may be configured to attenuate various or complimentary ranges of pressure oscillations, in which differently configured acoustic dampers 100 are disposed at various circumferential locations of the combustor assembly 50. In still various embodiments, one or more acoustic dampers 100 may be included with each circumferential segment of the dome wall 56 (e.g., such as shown as separated or including a gap 57 between circumferentially adjacent portions of the dome wall 56).

In various embodiments, such as shown in FIG. 6, the acoustic dampers 100 may be disposed in generally symmetric arrangement along the circumferential direction C. In other embodiments, the acoustic dampers 100 may be arranged in asymmetric arrangement along the circumferential direction C. For example, in one embodiment, the acoustic dampers 100 are unevenly spaced between one another along the circumferential direction C. In another embodiment, the acoustic dampers 100 are unevenly spaced along the radial direction R from the axial centerline 12 (shown in FIG. 1). In yet another embodiment, some segments of the dome wall 56 include acoustic dampers 100 and others do not include acoustic dampers 100, such that the arrangement of acoustic dampers 100 is uneven or asymmetric along the circumferential direction C. In still other embodiments, the acoustic dampers 100 may generally occupy the combustor assembly 50 as shown in FIG. 6 and define different acoustic damping properties (e.g., different volumes, areas, or lengths of the damper assembly 100 as generally described in regard to FIGS. 1-5) such that the properties are dispersed unevenly or asymmetrically along the circumferential direction C.

All or part of the combustor assembly may be part of a single, unitary component and may be manufactured from any number of processes commonly known by one skilled in the art. These manufacturing processes include, but are not limited to, those referred to as “additive manufacturing” or “3D printing”. Additionally, any number of casting, machining, welding, brazing, or sintering processes, or any combination thereof may be utilized to construct the acoustic damper 100 separately or integral to one or more other portions of the combustor 50, such as, but not limited to, the dome wall 56. Furthermore, the combustor assembly 50 may constitute one or more individual components that are mechanically joined (e.g. by use of bolts, nuts, rivets, or screws, or welding or brazing processes, or combinations thereof) or are positioned in space to achieve a substantially similar geometric, aerodynamic, or thermodynamic results as if manufactured or assembled as one or more components. Non-limiting examples of suitable materials include high-strength steels, nickel and cobalt-based alloys, and/or metal or ceramic matrix composites, or combinations thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combustor assembly for a gas turbine engine, the combustor assembly defining a combustion chamber and a diffuser cavity disposed upstream of the combustion chamber, the combustor assembly comprising:
an acoustic damper comprising an aft wall adjacent to the combustion chamber and a forward wall adjacent to the diffuser cavity, and a connecting wall extended at least partially along the longitudinal direction and coupled to the aft wall and the forward wall, wherein a damper cavity is defined by the connecting wall, the aft wall, and the forward wall.

2. The combustor assembly of claim 1, wherein the aft wall defines a damper passage extended from the combustion chamber to the damper cavity.

3. The combustor assembly of claim 2, wherein the aft wall defines a first orifice and a second orifice each at the damper passage, wherein the first orifice provides fluid communication from the damper cavity to the damper passage, and wherein the second orifice provides fluid communication from the combustion chamber to the damper passage.

4. The combustor assembly of claim 3, wherein the damper passage extends at least partially along the longitudinal direction from the first orifice to the second orifice.

5. The combustor assembly of claim 4, wherein the aft wall defines the damper passage extended at least partially along a radial direction, wherein the damper passage defines a serpentine passage, an angled passage at least partially along the radial direction, or both.

6. The combustor assembly of claim 1, wherein the forward wall defines a third orifice providing fluid communication from the diffuser cavity to the damper cavity.

7. The combustor assembly of claim 1, wherein the connecting wall defines a cylindrical, oblong, or polyhedron wall defining the damper cavity.

8. The combustor assembly of claim 1, wherein the acoustic damper further comprises an intermediate wall disposed within the damper cavity between the aft wall and the forward wall, and wherein the intermediate wall is coupled to at least a portion of the connecting wall, and further wherein the intermediate wall defines two or more damper cavity subsections.

9. The combustor assembly of claim 8, wherein the intermediate wall defines an intermediate wall orifice extended through the intermediate wall.

10. The combustor assembly of claim 1, the combustor assembly further comprising:
an annular dome wall extended generally along the radial direction and adjacent to the combustion chamber, wherein the acoustic damper extends at least partially through the dome wall from the diffuser cavity and adjacent to the combustion chamber.

11. The combustor assembly of claim 10, wherein the aft wall of the acoustic damper and the dome wall together define a threaded interface.

12. The combustor assembly of claim 11, wherein an outer diameter of the aft wall defines a plurality of threads coupled to the dome wall.

13. The combustor assembly of claim 11, wherein the connecting wall of the acoustic damper comprises a radially extended portion forward of and adjacent to the threaded interface.

14. The combustor assembly of claim 1, wherein the combustor assembly comprises a plurality of acoustic dampers disposed in circumferential arrangement through the dome wall.

15. The combustor assembly of claim 14, wherein the acoustic dampers are in symmetric or asymmetric circumferential arrangement through the dome wall.

16. A gas turbine engine defining a longitudinal direction, a radial direction, and a circumferential direction, wherein an axial centerline extends therethrough along the longitudinal direction, and wherein the gas turbine engine defines an upstream end and a downstream end generally opposite of the upstream end along the longitudinal direction, the gas turbine engine comprising:
a combustor assembly defining a combustion chamber and a diffuser cavity disposed generally upstream of the combustion chamber, wherein the combustor assembly comprises an acoustic damper comprising an aft wall adjacent to the combustion chamber and a forward wall adjacent to the diffuser cavity, and a connecting wall extended at least partially along the longitudinal direction and coupled to the aft wall and the forward wall, wherein a damper cavity is defined by the connecting wall, the aft wall, and the forward wall.

17. The gas turbine engine of claim 16, wherein the aft wall defines a damper passage extended from the combustion chamber to the damper cavity, and wherein the aft wall defines a first orifice and a second orifice each at the damper passage, wherein the first orifice provides fluid communication from the damper cavity to the damper passage, and wherein the second orifice provides fluid communication from the combustion chamber to the damper passage.

18. The gas turbine engine of claim 16, wherein the forward wall defines a third orifice providing fluid communication from the diffuser cavity to the damper cavity.

19. The gas turbine engine of claim 16, the combustor assembly further comprising:
an annular dome wall extended generally along the radial direction and adjacent to the combustion chamber, wherein the acoustic damper extends at least partially through the dome wall from the diffuser cavity and adjacent to the combustion chamber, and wherein the connecting wall of the acoustic damper and the dome wall together define a threaded interface.

20. The gas turbine engine of claim 16, wherein the acoustic damper further comprises an intermediate wall disposed within the damper cavity between the aft wall and the forward wall, and wherein the intermediate wall is coupled to at least a portion of the connecting wall, and further wherein the intermediate wall defines two or more damper cavity subsections.
